(19) United States
(12) Patent Application Publication
(10) Pub. No.: US 2026/0290681 A1
(43) Pub. Date: Sep. 24, 2026

(54) ELECTRICAL APPARATUS COMPRISING AT LEAST ONE GELLED MATERIAL

(71) Applicant: ARKEMA FRANCE, Colombes (FR)

(72) Inventors: Jérôme BLANC, Pierre-Benite (FR); Jeremie WALKER, Pierre-Benite (FR); Bernard MONGUILLON, Colombes (FR)

(73) Assignee: ARKEMA FRANCE, Colombes (FR)

(21) Appl. No.: 18/868,837

(22) PCT Filed: Sep. 22, 2023
(86) PCT No.: PCT/FR2023/051463

§ 371 Date: Nov. 25, 2024

(30) Foreign Application Priority Data
Sep. 22, 2022 (FR) FR2209596

(51) Int. Cl. H01F 27/32; H01B 3/22; H01B 3/30; H01B 3/42; H01B 3/46; H01B 17/34; H01F 27/02; H01G 2/10

(52) U.S. Cl. CPC H01F 27/321; H01B 3/22; H01B 3/303; H01B 3/421; H01B 3/46; H01B 17/34; H01F 27/02; H01G 2/103

(57) ABSTRACT

An electrical apparatus including a coil, at least one composition including at least one dielectric fluid, preferably a dielectric liquid, and at least one material in gelled form, which are arranged inside the cavity of a housing, and wherein the ratio between the maximum volume occupied by the material in gelled form and the total volume of the cavity is less than 50%. Also, the use of a material in gelled form to prevent and/or minimize leaks of a composition including at least one dielectric fluid within an electrical apparatus, in particular a transformer or a capacitor.

The present invention relates to an electrical apparatus comprising at least one coil, at least one composition comprising at least one dielectric fluid, preferably a dielectric liquid, and at least one material in gelled form, which are arranged inside the cavity of a housing, and wherein the ratio between the maximum volume occupied by the material in gelled form and the total volume of the cavity is less than 50%.

The invention also relates to the use of a material in gelled form to prevent and/or minimize leaks of a composition comprising at least one dielectric fluid within an electrical apparatus, in particular a capacitor or a transformer.

Electrical apparatuses or equipment, for example electrical capacitors and transformers, comprise at least one coil and a dielectric fluid which are arranged in a housing which may be conductive or insulating. The coil, corresponding to the active parts of the electrical apparatus, generally consists of an assembly, in particular of one or more windings or stacks, of a plurality of layers, connected to one another, alternating successively between an electronically conductive layer and an electronically insulating layer. The coil may be impregnated with at least one dielectric fluid and arranged inside a housing or be immersed in a housing already filled with at least one dielectric fluid. By way of illustration, the coil may correspond to windings consisting of polypropylene sheets and metal sheets, in particular aluminum sheets, impregnated with a dielectric fluid, for example an oil having a high dielectric constant, and be positioned inside a housing.

The housing, having for example a generally oblong shape, is commonly sealed at its ends by removable closure means intended to ensure the sealing and protection of electrical apparatuses, in particular between the active parts of the electrical apparatus and the surrounding environment.

However, such electrical apparatuses most often have a lifespan which may extend up to a period of 30 or 50 years depending on their application. During their operation, external and/or internal stresses are liable to cause thermal expansion and/or mechanical deterioration of the closure means of the housing, thus impairing the sealing and mechanical strength of the active parts of the electrical apparatus and increasing the risks of dielectric fluid leaking to the surrounding environment.

In particular, when the housing is sealed with welding means, the latter may oxidize over time, resulting in the formation of rust spots that may degrade the sealing of the electrical apparatuses.

In other words, the degradation of these active parts and the risks of dielectric fluid leaks, in particular at the connectors between the active parts and the electrical network, are likely to increase over time, in particular during the aging of the electrical apparatuses.

Dielectric fluid leaks pose a certain number of drawbacks because they are not only detrimental to the electrical performance of the electrical apparatuses, inducing high maintenance costs, but they can also prove harmful to health and the environment.

Moreover, dielectric fluid leaks also pose safety problems, including dangers of flame propagation and acceleration in the event of fire and rupture of the housing.

In order to overcome these drawbacks, solutions consisting in completely coating the active parts of the electrical apparatuses in a gellable composition or a polymerizable resin have been proposed.

To this end, a method has already been implemented which consists in introducing the active parts of an electrical apparatus into a housing and then casting a gellable composition so as to completely fill the free spaces located between the active parts of the electrical apparatus and the housing. Once the operation of filling the housing is completed, a gelling reaction is carried out completely at ambient temperature.

As a variant, a method has also been implemented which consists in completely coating the active parts of the electrical apparatus in a polymerizable resin and then, once polymerization has been completed, in introducing the assembly into a housing.

Nevertheless, the electrical performance of the equipment thus obtained does not prove to be completely satisfactory. Specifically, air bubbles are likely to form in the active parts of the electrical apparatuses, which can cause harmful effects on their operation, degrade their dielectric strength and lead to poor impregnation of the film constituting the active parts.

In light of the foregoing, one of the objectives of the present invention is therefore to prevent, or even eliminate, the risks of leaks of the dielectric fluid in an electrical apparatus while maintaining satisfactory electrical performance.

In other words, one of the aims of the present invention is to propose an electrical apparatus for which the risks of leaks of the dielectric fluid are minimized, or even eliminated, even after aging, while retaining satisfactory electrical performance during its use.

In particular, the object of the invention is to propose an electrical apparatus having good dielectric performance, in particular a satisfactory dielectric strength, which is also capable of meeting a certain number of criteria, in particular sanitary, ecological and/or safety criteria.

One subject of the present invention is thus in particular an electrical apparatus comprising:
a housing provided with a cavity, preferably a longitudinal cavity,
a coil, at least one composition comprising at least one dielectric fluid, preferably a dielectric liquid, and at least one material in gelled form, which are arranged inside the cavity,
the material in gelled form occupying a maximum volume of less than 50% of the total volume of the cavity.

The electrical apparatus according to the invention thus has satisfactory electrical performance and risks of leaks of the dielectric fluid which are reduced, or even eliminated, including after its aging, in particular under increasing DC voltages.

The electrical apparatus according to the invention has in particular better electrical performance than electrical apparatuses whose active parts, impregnated and/or immersed in a dielectric fluid, are completely coated in a polymerizable resin or a gellable composition.

Specifically, the risks of air bubbles forming in the active parts of the electrical apparatus according to the invention during its operation are greatly reduced, or even eliminated, compared with electrical apparatuses whose active parts are completely coated in a polymerizable resin or a gellable composition.

Furthermore, the mechanical strength and sealing of the active parts of the electrical apparatus according to the invention have the advantage of being suitably protected from the surrounding environment.

In particular, the material in gelled form makes it possible to effectively protect the most fragile areas of the electrical apparatus while retaining most of the dielectric fluid inside the electrical apparatus.

In particular, the material in gelled form makes it possible to effectively protect the connections between the active parts of the electrical apparatus and the electrical network and also the welded parts of the electrical apparatus.

Thus, the material in the form of gel makes it possible to effectively control the thermal expansion within the electrical apparatus.

The material in the form of gel also makes it possible to reduce any thermal expansion phenomena caused by the surrounding environment on the active parts of the electrical apparatus; in particular the material in the form of gel also has the advantage of compensating for thermal expansion and shrinkage of the dielectric fluid.

The electrical apparatus according to the invention thus has the advantage of being able to meet a certain number of criteria, for example sanitary, ecological and/or safety criteria, including after its aging under increasing DC voltages, while ensuring satisfactory electrical performance, in particular while displaying high dielectric performance, for example good dielectric strength, and also better resistance to partial discharges.

Another subject of the invention is the use of a material in gelled form to prevent, and possibly eliminate, leaks of a composition comprising at least one dielectric fluid in an electrical apparatus as defined above.

A further subject of the present invention is a method for manufacturing an electrical apparatus as described above.

Other subjects, features, aspects and advantages of the invention will become even more clearly apparent on reading the description and examples which follow.

In the text hereinbelow, unless otherwise indicated, the limits of a range of values are included in that range, especially in the expressions “between” and “ranging from . . . to . . . ”.

Furthermore, the expressions “at least one” and “at least” used in the present description are respectively equivalent to the expressions “one or more” and “greater than or equal to”.

### Electrical Apparatus

Electrical apparatus means any type of electrical equipment, whether transformers, electrostatic storage equipment, electricity transport elements or electrical connection elements, such as power transformers, distribution transformers, traction transformers, measurement transformers, special transformers, circuit breakers, capacitors, splitters, bushings, load tap changers, and others, to mention only the main electrical apparatuses or equipment comprising at least one dielectric fluid.

Preferably, the electrical apparatus is chosen from the group consisting of transformers, in particular measurement transformers, capacitors, bushings and load tap changers.

More preferably, the electrical apparatus is chosen from the group consisting of measurement transformers and capacitors, in particular capacitors, especially low-voltage capacitors, medium-voltage capacitors and high-voltage capacitors.

According to the present invention, the coil, the composition comprising at least one dielectric fluid and the material in gelled form are arranged inside the cavity of the housing, and the material in gelled form occupies a maximum volume of less than 50% with respect to the total volume of the cavity.

Preferably, the material in gelled form occupies a maximum volume of less than or equal to 40%, more preferably of less than or equal to 30%, even more preferably of less than or equal to 20%, and more particularly of less than or equal to 15%, with respect to the total volume of the cavity of the housing.

In other words, the ratio between the maximum volume occupied by the material in gelled form and the total volume of the cavity is less than 50%, preferably less than or equal to 40%, more preferably less than or equal to 30%, even more preferably less than or equal to 20%, and more particularly less than or equal to 15%.

Even more preferably, the material in gelled form occupies a maximum volume of less than or equal to 20%, more particularly of less than or equal to 15%, with respect to the total volume of the cavity.

The housing may have any types of geometric shapes, preferably a cylindrical or rectangular shape.

The housing may be conductive or insulating and may be made with all types of materials.

The housing may be made of ceramic, for example of porcelain, of a metallic material, in particular of ferrous metals, in particular of steel or of stainless steel, or of nonferrous metals.

According to the present invention, the cavity may have any types of geometric shapes.

Thus, the cavity is in particular a cavity capable of having all types of geometric shapes.

According to a general feature of the invention, the cavity may have at least one longitudinal part.

According to a preferred feature of the invention, the cavity may consist of said longitudinal part. In this case, the cavity is longitudinal.

Alternatively, the cavity may have other types of geometric shapes, for example a U-shape.

In this case, the cavity has two longitudinal parts spaced apart from one another and connected to one another by a transverse part.

Advantageously, the cavity is a longitudinal cavity.

According to the present invention, one end of the cavity corresponds to the distal part of the cavity which opens onto at least one end face of the housing, thus forming an opening.

In other words, the cavity comprises at least one end, in particular one or two ends, opening onto at least one end face of the housing, thus forming at least one opening, preferably one or two openings.

According to a preferred embodiment, the cavity has at least one longitudinal part comprising at least one end opening onto at least one end face of the housing.

In other words, according to this embodiment, the cavity has at least one longitudinal part provided with at least one end opening onto at least one end face of the housing.

Preferably, the cavity is a longitudinal cavity comprising at least one end opening onto at least one end face of the housing.

Preferably, the cavity is a longitudinal cavity comprising one end opening onto an end face of the housing.

Preferably, the cavity is a longitudinal cavity comprising two ends opening onto the two opposite end faces of the housing.

According to another embodiment, the cavity has a U-shape, i.e. has two longitudinal parts spaced apart from one another and connected to one another by a transverse part, and comprises two ends opening onto the same end face of the housing, thus forming two openings appearing side by side on the same end face of the housing.

In particular, in this case, each longitudinal part comprises one end opening onto the same end face of the housing.

Advantageously, the material in gelled form is at least located at at least one end of the cavity, which makes it possible to more effectively protect the coil, in particular the mechanical strength and sealing of the active parts of the electrical apparatus with respect to the surrounding environment, and to further reduce the risks of leakage of the dielectric fluid, or even eliminate them.

Preferably, the material in gelled form is at least located at at least one end of the cavity, more preferably at at least two ends of the cavity.

Preferably, the material in gelled form is at least located at at least one end of a longitudinal cavity, more preferably at the two ends of a longitudinal cavity.

In other words, the material in gelled form is in particular distributed within the electrical apparatus according to the invention in at least one of the ends of the cavity, preferably at one end or at the two ends of a longitudinal cavity.

In particular, at least 10% by weight, or at least 50% by weight, or at least 90% by weight, or at least 92% by weight, or at least 94% by weight, or at least 96% by weight, or at least 98% by weight, of the total weight of the material in gelled form is located at at least one of the ends of the cavity, preferably at least at the two ends of a longitudinal cavity.

Preferably, the material in gelled form is at least located between at least one of the end faces of the housing and the dielectric fluid.

Preferably, the material in gelled form is not in contact with the coil.

The electrical apparatus according to the invention thus has the advantage of limiting the contacts between the coil and the material in gelled form.

In this way, the risks of air bubbles forming within the coil, which could hinder the proper functioning of the electrical apparatus, are reduced, or even eliminated.

Advantageously, the material in gelled form, located at least at one of the ends of the longitudinal cavity of the housing, preferably at the two ends of the longitudinal cavity of the housing, is not in contact with the coil.

According to one embodiment, the material in gelled form may be located at least in part between the composition comprising at least one dielectric fluid and the bore of the cavity, that is to say between the composition comprising at least one dielectric fluid and the inner surface of the cavity. In this case, the material in gelled form adheres in particular to the bore of the cavity.

In this way, the material in gelled form can be sandwiched at least in places between the composition comprising at least one dielectric fluid and the bore of the cavity.

The layer of material in gelled form partially sandwiched between the bore of the cavity and the composition comprising at least one dielectric fluid may in particular have a thickness of at least 100 μm, preferably ranging from 100 to 20000 μm, in particular ranging from 1000 to 10000 μm.

According to this embodiment, the material in gelled form may be located at one of the ends of the cavity, preferably at one or two ends of a longitudinal cavity, and may additionally be, partially or totally, sandwiched between the composition comprising at least one dielectric fluid and the bore of the cavity.

Furthermore, according to this embodiment, the chemical nature of the material in gelled form may be different when it is positioned on one of the distal parts of the cavity and when it is positioned between the bore of the cavity and the dielectric fluid. Preferably, the chemical nature is identical when it is positioned on one of the distal parts of the cavity and when it is positioned between the bore of the cavity and the composition comprising at least one dielectric fluid.

Furthermore, according to this embodiment, at least 50% by weight, or at least 90% by weight, or at least 92% by weight, or at least 94% by weight, or at least 96% by weight, or at least 98% by weight, or at least 99% by weight, of the total weight of the material in gelled form may be located at at least one end of the cavity, preferably at one end or at the two ends of a longitudinal cavity, and respectively, 50% or less by weight, or 10% or less by weight, or 8% or less by weight, or 6% or less by weight, or 4% or less by weight, or 2% or less by weight, or 1% or less by weight, of the total weight of the material in gelled form is located in part between the composition comprising at least one dielectric fluid and the bore of the cavity.

According to a preferred embodiment, the composition comprising at least one dielectric fluid is at least partially in direct contact with the cavity, preferably in direct contact with the bore of the cavity.

In other words, the composition comprising at least one dielectric fluid is at least in places in direct contact with the cavity, i.e. the dielectric fluid has one or more contact surfaces with the cavity, in particular with the bore of the cavity.

Thus, at these contact surfaces, the composition comprising at least one dielectric fluid is not separated from the cavity by the material in gelled form according to the invention.

According to an advantageous embodiment, the composition comprising at least one dielectric fluid is completely in direct contact with the bore of the cavity.

The electrical apparatus thus obtained has particularly improved electrical performance while preventing dielectric fluid leaks, making it the most reliable from an ecological, sanitary and safety point of view (especially in the event of fire).

Preferably, the cavity is longitudinal and the material in gelled form is located at one of the ends of the cavity, preferably at the two ends of the cavity.

More preferably, the material in gelled form is located at one of the ends of the longitudinal cavity, preferably at the two ends of the longitudinal cavity, and the composition comprising at least one dielectric fluid is completely in direct contact with the bore of the longitudinal cavity, i.e. with the inner surfaces of the longitudinal cavity of the housing.

In other words, the composition comprising at least one dielectric fluid is not separated from the cavity by a space filled with the material in gelled form according to the invention, over the whole of the inner surface of the cavity.

Preferably, the material in gelled form is located at at least one end of the cavity, preferably at one end or at the two ends of a longitudinal cavity, and may be in any form suitable for preventing dielectric fluid leaks, and may have a thickness ranging from 1 to 100 mm, preferably a thickness ranging from 5 to 50 mm.

Advantageously, the material in gelled form takes the form of a plug which may have a thickness ranging from 1 to 100 mm, preferably a thickness ranging from 5 to 50 mm.

Alternatively, the cavity has a U-shape. In this case, the cavity has two longitudinal parts spaced apart from one another and connected to one another by a transverse part, and comprises two ends opening onto the same end face of the housing, and the material in gelled form is at least located at one of the ends of the cavity, preferably at the two ends of the cavity.

Preferably, the material in the form of gel occupies a maximum volume of less than or equal to 30%, and the composition comprising at least one dielectric fluid, preferably a dielectric liquid, occupies a volume of greater than or equal to 70% in the cavity.

More preferably, the material in the form of gel occupies a maximum volume of less than or equal to 20%, and the composition comprising at least one dielectric fluid, preferably a dielectric liquid, occupies a volume of greater than or equal to 80% in the cavity.

In the context of the present invention, the coil, corresponding to the active parts of the electrical apparatus, positioned inside the cavity of the housing, may be impregnated with at least one dielectric fluid and/or be immersed, i.e. bathed, in at least one dielectric fluid.

According to one preferred feature of the present invention, the coil is immersed in at least one dielectric fluid.

According to another preferred feature, the coil is impregnated with at least one dielectric fluid by means of an impregnation process capable of being implemented before or after the introduction of the coil into the cavity of the housing, that is to say therefore inside or outside the cavity.

According to another preferred feature, the coil is first impregnated with at least one dielectric fluid and then is immersed in at least one dielectric fluid inside the cavity of the housing. In other words, the coil may be impregnated with at least one dielectric fluid outside the housing by means of an impregnation process and then, once the impregnation is completed, the coil may next be immersed in at least one dielectric fluid filling the cavity of the housing. In this case, the dielectric fluid used for impregnation and immersion may be identical or different, preferably identical.

According to a general feature, the material in the form of gel is immiscible with the composition comprising the dielectric fluid.

For the purposes of the present invention, the material in the form of gel and the composition comprising the dielectric fluid are separate and are immiscible with one another.

For the purposes of the present invention, the term “immiscible” is understood to mean that the material in the form of gel has a solubility of less than 0.1% by weight in the composition comprising the dielectric fluid in a temperature range ranging from −60 to 150° C., preferably ranging from −30 to 120° C.

The material in the form of gel may have a dielectric constant having a value of less than or equal to 10, preferably of less than or equal to 6, more preferably of less than or equal to 4.

The material in the form of gel may have a thermal resistance in a temperature range ranging from 50 to 200° C., in particular in a temperature range ranging from 40 to 90° C.

Preferably, the material in the form of gel is a resin chosen from the group consisting of silicone resins, polyurethane resins, polyester resins, polystyrene resins, polyethylene resins and mixtures thereof.

More preferably, the material in the form of gel is a resin chosen from the group consisting of silicone resins, polyurethane resins, and mixtures thereof.

Even more preferably, the material in the form of gel is a resin chosen from the group consisting of silicone resins.

For the purposes of the present invention, silicone is understood to denote any organosilicon polymers or oligomers, of variable molecular weight, obtained by polymerization and/or polycondensation of silanes, comprising at least one repetition of units in which the silicon atoms are connected to one another by oxygen atoms (siloxane bond —Si—O—Si—).

The siloxanes may be silicone, polysilane, polysilazane, polycarbosilane or polysilphenylene prepolymers.

Preferably, the material in the form of gel is a silicone resin having a cone penetrability ranging from 2 to 500 mm/10, in particular ranging from 5 to 350 mm/10, measured at a temperature of 25° C. according to the standard ISO2137.

Preferably, the material in the form of gel is a silicone resin, in particular made from a two-component mixture comprising a component A and a component B.

More preferably, the material in the form of gel is a silicone resin made from a mixture of two components, in a weight ratio of 1/1, sold under the trade name/BLUESIL ESA 6018-01A+BLUESIL ESA 6018-01B, having in particular a viscosity of 530 mPa·s at a temperature of 23° C., measured according to the standard ISO 3219.

According to a general feature of the invention, the material in the form of gel and the composition comprising at least one dielectric fluid are in particular distinct, with in particular the composition comprising at least one dielectric fluid not being in the form of a phase dispersed in the material in the form of gel.

For the purposes of the present invention, the term “dielectric fluid” means a fluid which does not conduct electricity (or is only sparingly conductive) but allows electrostatic forces to be exerted.

According to a general feature of the invention, the dielectric fluid may be a dielectric gas, a dielectric liquid or a mixture of dielectric gas and dielectric liquid.

Preferably, the dielectric fluid is a dielectric liquid.

The dielectric liquid may have a kinematic viscosity, measured at a temperature of 40° C., ranging from 1 to 51 mm²·s⁻¹, preferably ranging from 1 to 35 mm²·s⁻¹ measured according to the standard ISO 3104.

The dielectric fluid may be chosen from the group consisting of mineral oils, synthetic oils, in particular aromatic hydrocarbons, aliphatic hydrocarbons, silicone oils, and synthetic esters, vegetable oils and natural esters, and mixtures thereof.

The synthetic oils are preferably chosen from the group consisting of aromatic hydrocarbons, aliphatic hydrocarbons, silicone oils, synthetic esters, and mixtures thereof.

Among the aromatic hydrocarbons, mention may be made in particular of alkylbenzenes, alkyldiphenylethanes (for example phenylxylylethane (PXE), phenylethylphenylethane (PEPE)), monoisopropylbiphenyl (MIPB), 1,1-diphenylethane (1,1-DPE), alkylnaphthalenes (for example diisopropylnaphthalene (DIPN)), methylpolyarylmethanes (for example benzyltoluene (BT) and dibenzyltolulene (DBT)), and mixtures thereof.

In said aromatic hydrocarbons, it should be understood that at least one ring is aromatic and that, optionally, one or more other ring(s) present can be partially or completely unsaturated.

Among the aliphatic hydrocarbons, mention may be made in particular of poly (alpha) olefins (PAO), for example polyisobutenes (PIB) or olefins of vinylidene type, such as those sold, for example, by Soltex Inc.

Among the silicone oils, mention may be made in particular of linear silicone oils of the polydimethylsiloxane type, such as, for example, those sold by Wacker under the trade name Wacker® AK.

Among the synthetic esters, mention may be made in particular of esters of the phthalic type, in particular alkyl phthalates such as dioctyl phthalate (DOP) or diisononyl phthalate (DINP) (sold, for example, by BASF).

Mention may also be made of esters resulting from the reaction between a polyalcohol and an organic acid, in particular an acid chosen from saturated or unsaturated C₄ to C₂₂ organic acids. Mention may be made, as nonlimiting examples of such organic acids, of undecanoic acid, heptanoic acid, octanoic acid, palmitic acid, and mixtures thereof. Among the polyols which can be used for the synthesis of the abovementioned esters, nonlimiting examples that may be mentioned include pentaerythritol.

Thus, the synthetic esters resulting from the reaction between a polyalcohol and an organic acid are, for example, the products of the Midel® range, such as, for example, Midel® 7131, or from the Mivolt® range, such as, for example, Mivolt® DFK and Mivolt® DF7 from M&I Materials, or else the esters of the Nycodiel range from Nyco.

Among the natural esters and vegetable oils, mention may be made in particular of the products resulting from oily seeds or from other sources of natural origin. Mention may be made, by way of example and in a nonlimiting way, of FR3™ or else Envirotemp™, which are sold by Cargill, or else Midel eN 1215 sold by M&I Materials.

Among the vegetable oils, mention may also be made of rapeseed oil, corn oils, castor oil and soybean oils and mixtures thereof.

Among the mineral oils, mention may be made in particular of paraffinic oils and naphthenic oils, such as the dielectric oils of the Nytro family, sold by Nynas (in particular Nytro Taurus, Nytro Libra, Nytro 4000X and Nytro 10XN), and Diala family, sold by Shell.

Preferably, the dielectric fluid is free of esters of the phthalic type, in particular alkyl phthalates such as dibutyl phthalate and dioctyl phthalate.

Preferably, the dielectric fluid is a synthetic oil, in particular chosen from the group consisting of aromatic hydrocarbons.

Advantageously, the dielectric fluid is chosen from the group consisting of methylpolyarylmethanes.

More advantageously, the dielectric fluid is chosen from the group consisting of mixtures based on benzyltoluene and one or more aromatic compounds, other than benzyltoluene, as described above, in particular dibenzyltoluene or 1,1-diphenylethane.

More advantageously, the dielectric fluid is a mixture comprising benzyltoluene and one or more aromatic compounds, other than benzyltoluene, as described above, in particular dibenzyltoluene or 1,1-diphenylethane; benzyltoluene being present in a concentration of greater than or equal to 30% by weight, preferably present in a concentration of greater than or equal to 40% by weight, more preferably in a concentration of greater than or equal to 50% by weight, even more preferably in a concentration of greater than or equal to 60% by weight, with respect to the total weight of said mixture.

More preferably, the mixtures of benzyltoluenes and of dibenzyltoluenes comprise from 70 to 85% by weight of benzyltoluene and from 15 to 30% by weight of dibenzyltoluene, with respect to the total weight of the benzyltoluene/dibenzyltoluene mixture.

Even more preferably, the mixtures of benzyltoluenes and of dibenzyltoluenes comprise from 70 to 80% by weight of benzyltoluene and from 20 to 30% by weight of dibenzyltoluene, with respect to the total weight of the benzyltoluene/dibenzyltoluene mixture.

The composition may also comprise one or more additives and/or fillers well known to a person skilled in the art and chosen, for example, in a nonlimiting manner, from the group consisting of antioxidants, passivators, pour point depressants, decomposition inhibitors, fragrances and flavorings, colorants, preserving agents, and others, and mixtures thereof.

Among the antioxidants which can be advantageously used, mention may be made in particular, by way of nonlimiting examples, of phenolic antioxidants, such as, for example, dibutylhydroxytoluene, butylhydroxyanisole, tocopherols, and also the acetates of these phenolic antioxidants; but also antioxidants of amine type, such as, for example, phenyl-α-naphthylamine, of diamine type, for example N,N′-di-(2-naphthyl)-paraphenylenediamine, but also ascorbic acid and its salts, esters of ascorbic acid, alone or as mixtures of two or more of them or with other components, such as, for example, green tea extracts or coffee extracts.

A very particularly suitable antioxidant is that commercially available from Brenntag under the trade name Ionol®.

The passivators which can be used as additives in the composition which can be used in the context of the present invention are of any type known to a person skilled in the art and are advantageously chosen from triazole derivatives, benzimidazoles, imidazoles, thiazole or benzothiazole. Mention may be made, by way of example and in a nonlimiting manner, of dioctylaminomethyl-2,3-benzotriazole and 2-dodecyldithioimidazole.

Mention may be made, among the pour point depressants which can be present in the composition which can be used in the context of the present invention, by way of nonlimiting examples, of sucrose fatty acid esters or acrylic polymers, such as poly(alkyl methacrylate) or else poly(alkyl acrylate).

The preferred acrylic polymers are those for which the molecular weight is between 50000 g mol⁻¹ and 500000 g mol⁻¹. Examples of these acrylic polymers include polymers which can contain linear alkyl groups comprising from 1 to 20 carbon atoms.

Mention may be made, among these, and still by way of nonlimiting examples, of poly(methyl acrylate), poly(methyl methacrylate), poly(heptyl acrylate), poly(heptyl methacrylate), poly(nonyl acrylate), poly(nonyl methacrylate), poly(undecyl acrylate), poly(undecyl methacrylate), poly(tridecyl acrylate), poly(tridecyl methacrylate), poly(pentadecyl acrylate), poly(pentadecyl methacrylate), poly(heptadecyl acrylate) and poly(heptadecyl methacrylate).

An example of such a pour point depressant is commercially available from Sanyo Chemical Industries Ltd under the trade name Aclube.

According to a very particularly preferred aspect, the composition according to the present invention comprises at least one decomposition inhibitor as additive.

The decomposition inhibitor can be of any type well known to a person skilled in the art and in particular can be chosen from carbodiimide derivatives, such as diphenylcarbodiimide, ditolylcarbodiimide, bis(isopropylphenyl) carbodiimide or bis(butylphenyl) carbodiimide, but also from phenyl glycidyl ethers, or esters, alkyl glycidyl ethers, or esters, 3,4-epoxycyclohexylmethyl 3,4-epoxycyclohexanecarboxylate, compounds of the anthraquinone family, such as, for example, β-methylanthraquinone sold under the name “BMAQ”, epoxide derivatives, such as vinylcyclohexene diepoxides, 3,4-epoxy-6-methylcyclohexylmethyl 3,4-epoxy-6-methylhexanecarboxylate, phenol novolak type epoxy resins, bisphenol A diglycidyl ether epoxys, such as BADGE, or CEL 2021P, available in particular from Whyte Chemicals.

The content by weight of the additive or additives optionally present in the composition according to the present invention can range from 0.0001% to 5% by weight, preferably from 0.001% to 3% by weight and more preferably from 0.01% to 2% by weight, limits included, with respect to the total weight of the composition.

Preferably, the composition according to the invention comprises a mixture of benzyltoluene and of one or more aromatic compounds, other than benzyltoluene, as defined above, in particular dibenzyltoluene or 1,1-diphenylethane, sold in particular under the trade names Jarylec® C101 and Jarylec® C101D by Arkema, or SAS 60® by JX Nippon Chemical Texas Inc.

Advantageously, the material in the form of gel is a resin chosen from the group consisting of silicone resins and the composition comprises a mixture of benzyltoluene and one or more aromatic compounds, other than benzyltoluene, as defined above, in particular dibenzyltoluene or 1,1-diphenylethane, the benzyltoluene being present in a mass concentration of greater than or equal to 30% by weight, preferably present in a mass concentration of greater than or equal to 40% by weight, more preferably in a mass concentration of greater than or equal to 50% by weight, even more preferably in a mass concentration of greater than or equal to 60%, with respect to the total weight of said mixture.

According to the present invention, the term “coil” is understood to mean any assembly, in particular any winding or stack, of a plurality of layers, connected to one another, alternating successively between an electronically conductive layer and an electronically insulating layer.

The electronically conductive layer is in particular a metal layer, for example an aluminum or copper layer, or a doubly metallized paper sheet. Preferably, the electronically conductive layer is an aluminum sheet.

The electronically insulating layer may be chosen from the group consisting of paper, a polyolefin, in particular polypropylene, a polyester, or mixtures thereof.

Preferably, the electronically insulating layer is a polyolefin layer, in particular a polypropylene layer.

Preferably, the coil is an assembly, in particular a winding, of a layer of aluminum and a layer of polyolefin, in particular polypropylene.

Advantageously, the coil is an assembly alternating successively between a plurality of layers of aluminum and layers of polyolefin, in particular polypropylene, impregnated with at least one dielectric fluid, in particular chosen from the group consisting of mixtures of benzyltoluenes and of one or more aromatic compounds, other than benzyltoluene, as defined above, in particular dibenzyltoluene or 1,1-diphenylethane, more precisely those described above.

The coil can be wrapped in paper or kraft-type cardboard.

According to an advantageous embodiment, the invention relates to an electrical capacitor or a transformer, in particular a measurement transformer, comprising:
a housing provided with a cavity, preferably a longitudinal cavity,
a coil, at least one composition comprising at least one dielectric fluid, preferably a dielectric liquid, and at least one material in gelled form, which are arranged inside the cavity,
the material in gelled form occupying a maximum volume of less than 50%, preferably less than or equal to 40%, preferably less than or equal to 30%, more preferably less than or equal to 20%, even more preferably less than or equal to 15%, of the total volume of the cavity.

According to this embodiment, the dielectric fluid is advantageously a mixture of benzyltoluene and of one or more aromatic compounds, other than benzyltoluene, as defined above, in particular dibenzyltoluene or 1,1-diphenylethane, and the material in the form of gel being a silicone resin.

According to one embodiment, the invention relates to an electrical apparatus, comprising:
a housing provided with a cavity, preferably a longitudinal cavity,
at least one coil and at least one composition comprising at least one dielectric fluid, which are arranged inside the cavity,
at least one plug formed of a material in gelled form;
the electrical apparatus further comprising material in gelled form interposed between the composition comprising at least one dielectric fluid and the bore of the cavity and spaced apart from said plug.

According to this advantageous embodiment, the material in gelled form which is interposed between the composition comprising the dielectric fluid and the bore of the cavity may be identical or different, preferably identical, to the material in gelled form forming the plug.

According to this embodiment, the electrical apparatus, the composition comprising the dielectric fluid, the coil and the cavity are as described above.

According to this embodiment, the material in gelled form occupies a maximum volume of less than 50% with respect to the total volume of the cavity.

According to this embodiment, the electrical apparatus is preferably a capacitor or a transformer, in particular a measurement transformer.

According to an advantageous embodiment, the electrical apparatus comprises:
a housing provided with a cavity, preferably a longitudinal cavity, as described above,
a coil and at least one composition comprising at least one dielectric fluid, which are arranged inside the cavity, as described above; the composition comprising at least the dielectric fluid being at least partially in direct contact with the cavity,
a material in gelled form, as described above, arranged inside the cavity and at least located at one of the ends of the cavity.

According to this advantageous embodiment, the composition comprising the dielectric fluid shares at least one contact surface with the cavity, in particular with at least the bore of the cavity.

Preferably, according to this advantageous embodiment, the composition comprising the dielectric fluid is entirely in direct contact with the bore of the cavity, i.e. with one of the inner surfaces of the cavity.

According to this embodiment, the electrical apparatus, the composition comprising the dielectric fluid, the coil and the cavity are as described above.

Preferably, according to this embodiment, the material in gelled form occupies a maximum volume of less than 50% with respect to the total volume of the cavity.

### Use

The present invention also relates to the use of a material in gelled form to prevent, and possibly eliminate, leaks of a composition comprising at least one dielectric fluid, as defined above, in an electrical apparatus as defined above.

In particular, the electrical apparatus is a transformer, in particular a measurement transformer, or a capacitor.

In other words, the invention relates to the use of a material in gelled form inside an electrical apparatus, as defined above, to prevent, and possibly eliminate, leaks of a composition comprising at least one dielectric fluid.

In other words, the invention relates in particular to the use of a material in gelled form to prevent, and possibly eliminate, leaks of a composition comprising at least one dielectric fluid in an electrical apparatus comprising:
a housing provided with a cavity, preferably a longitudinal cavity,
a coil and at least one composition comprising at least one dielectric fluid, preferably a dielectric liquid, which are arranged inside the cavity,
said material in gelled form being arranged inside the cavity and occupying a maximum volume of less than 50% of the total volume of the cavity.

### Method

Another subject of the present invention is a method for manufacturing an electrical apparatus as described above.

Preferably, the method comprises:
at least one step of inserting a coil, as described above, into the cavity of the housing,
optionally, at least one step of impregnating the coil with a composition comprising at least one dielectric fluid, as described above,
at least one step of filling the cavity with a gellable composition,
at least one step of gelling said gellable composition to obtain a material in gelled form as described above;
such that the material in gelled form occupies a maximum volume of less than 50% of the total volume of the cavity.

More preferably, the method comprises:
at least one step of inserting a coil, as described above, into the cavity of the housing,
at least one step of impregnating the coil with a composition comprising at least one dielectric fluid, as described above, at least one step of filling the cavity with a gellable composition,
at least one step of gelling said gellable composition to obtain a material in gelled form as described above;
such that the material in gelled form occupies a maximum volume of less than 50% of the total volume of the cavity.

The step of impregnating the coil can be implemented before or after the step of inserting said coil into the cavity of the housing, preferably after the insertion step.

The gelling step may proceed at a temperature ranging from 5° C. to 70° C., preferably from 23° C. to 70° C.

The step of filling the cavity with a gellable composition may take place before the step of inserting the coil into the cavity, or after gelling said composition.

The filling step may comprise one or more, preferably one or two, steps of filling the cavity with a gellable composition.

The filling step may comprise depositing the gellable composition on at least one end of the cavity and/or partially or totally on the bore of the cavity.

Preferably, the method comprises:
i) at least one step of partially filling a cavity of the housing with a gellable composition,
ii) at least one step of gelling said gellable composition to obtain a material in gelled form as described above,
iii) at least one step of inserting a coil, as described above, into the cavity of the housing,
iv) at least one step of impregnating the coil with a composition comprising at least one dielectric fluid, as described above,
v) at least one step of filling the remainder of the housing cavity with said gellable composition,
vi) at least one step of gelling the gellable composition added in step v) to obtain a material in gelled form as described above;
   such that the material in gelled form occupies a maximum volume of less than 50% of the total volume of the cavity.

The partial filling step i) may comprise depositing the gellable composition on at least one end of the cavity and/or partially or totally on the bore of the cavity.

The gelling step ii) can proceed at a temperature ranging from 5° C. to 70° C., preferably from 23° C. to 70° C.

The impregnation step iv) can be implemented before or after the step iii) of inserting the coil into the cavity of the housing, preferably after the step iii).

The impregnation step may, for example, comprise:
a step of impregnating the coil under reduced pressure at a temperature which may range from 5° C. to 100° C., preferably from 23° C. to 100° C., with the composition comprising the dielectric fluid, for a period which may range from 48 to 200 hours, preferably from 48 to 150 hours,
possibly followed by a step of cooling the coil to ambient temperature, for example to a temperature of 23° C.

The filling step v) may comprise depositing said gellable composition on the entire bore and/or at least one end of the cavity, different from the end of step i).

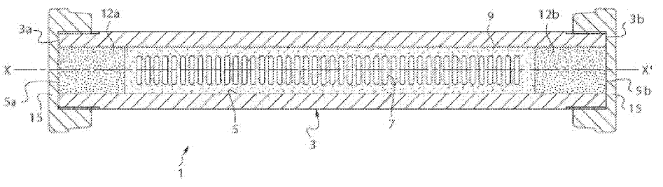

Other features and advantages of the invention will become even more clearly apparent from the detailed examination of an embodiment taken by way of nonlimiting example of an electrical apparatus according to the invention and illustrated by the appended drawing, in which FIG. 1 shows a sectional view of the capacitor according to the invention.

As illustrated in the single FIGURE, the electrical apparatus extends along a longitudinal general axis X-X′. In FIG. 1, the electrical apparatus 1 is shown in a position assumed to be horizontal.

As a variant, the electrical apparatus 1 may also be in a vertical position.

The electrical apparatus 1 comprises a housing 3, shown here schematically. The housing 3 may be electrically insulating, for example made of a ceramic material, for example porcelain, or electrically conductive, for example made of a metallic material, in particular with ferrous metals.

The housing 3 is shown in FIG. 1 with a rectangular shape but may have any type of geometric shapes.

The housing 3 is provided with a longitudinal cavity 5. In the exemplary embodiment illustrated, the cavity 5 is through-going in the axial direction. The cavity 5 has two ends 5a and 5b which open respectively onto the end faces 3a, 3b of the housing 3, thus forming two openings.

Alternatively, the cavity 5 could not be through-going. In this case, the cavity 5 has a single end which opens onto only one of the two end faces 3a, 3b of the housing 3.

As a further alternative, the cavity 5 has a U-shape. In this case, the cavity 5 has two longitudinal parts spaced apart from one another and connected to one another by a transverse part, and comprises two ends 5a and 5b opening onto the same end face 3a and 3b of the housing 3.

The electrical apparatus 1 also comprises a coil 7 which is arranged inside the cavity 5 and immersed in a composition 9 comprising a dielectric fluid.

As a variant, the coil 7 may be impregnated with the composition 9 over some or all of its surface by means of an impregnation process capable of being implemented before or after the introduction of the coil 7 into the cavity 5 of the housing 3, that is to say therefore inside or outside the cavity 5.

As a further variant, the coil 7 may first be impregnated with the composition 9 over all or part of its surface, outside the cavity 5, by an impregnation process and then the coil 7 may be inserted into the cavity 5 previously filled with the composition 9.

The impregnation process may, for example, comprise:
a step of impregnating the coil 7 under reduced pressure at a temperature which may range from 5° C. to 100° C., preferably from 23° C. to 100° C., with the composition 9, for a period which may range from 48 to 200 hours, preferably from 48 to 150 hours,
the coil 7 can then be cooled to a temperature of 23° C.

As indicated above, the coil 7 is preferably a winding alternating successively between layers of aluminum and layers of polyolefin, for example consisting of an alternating succession of aluminum sheets and polyolefin sheets, in particular polypropylene sheets.

As indicated above, the composition 9 comprises a dielectric fluid, which is preferably a dielectric liquid, and is advantageously a mixture of benzyltoluene and of one or more aromatic compounds, other than benzyltoluene, as defined above, in particular dibenzyltoluene or 1,1-diphenylethane.

Advantageously, the composition 9 may be sold under the trade names Jarylec® C101 and Jarylec® C101D by Arkema or the trade name SAS 60® by JX Nippon Chemical Texas Inc.

As illustrated in FIG. 1, the composition 9 is arranged so as to be entirely in direct contact with the bore of the cavity 5.

In other words, the composition 9 is not separated from the bore of the cavity 5 by an empty space or a free space.

The electrical apparatus 1 further comprises a material 12 in gelled form which is immiscible with the composition 9. The material 12 is distinct from the composition 9. The material 12 is preferably chosen from the group consisting of silicone resins, polyurethane resins, polyester resins, polystyrene resins and polyethylene resins and mixtures thereof.

Advantageously, the material 12 in gelled form is a resin chosen from the group consisting of silicone resins, polyurethane resins and mixtures thereof.

More preferably, the material 12 in gelled form is chosen from the group consisting of silicone resins.

The material 12 in gelled form is arranged inside the cavity 5 of the housing. The material 12 in gelled form comes into contact against the bore of the cavity 5.

As shown in the single FIGURE, the material 12 in gelled form occupies a maximum volume of less than or equal to 20% with respect to the total volume of the cavity 5. In other words, the ratio between the maximum volume occupied by the material 12 in gelled form and the total volume of the cavity is less than or equal to 20%.

According to the present invention, the material 12 in gelled form may also occupy a larger volume in the cavity 5, in particular a maximum volume of less than 50% with respect to the total volume of the cavity 5.

As shown in the single FIGURE, the material 12 in gelled form is located at each end 5a and 5b of the cavity 5. In particular, the material 12 is located between the two end faces 3a and 3b of the housing 3 and the composition 9. In this example, the material 12 in gelled form thus takes the form of two blocks or plugs 12a, 12b. The material 12 in gelled form thus blocks off the cavity 5.

The inner face of each plug 12a, 12b formed by the material 12 in gelled form is in contact with the composition 9.

In particular, the material 12 is not in contact with the coil 7, i.e. with the active parts of the electrical apparatus 1.

The positioning of the material 12 thus makes it possible to effectively prevent leaks of the composition 9 comprising the dielectric fluid and ensures the protection of the coil 7 with respect to the external environment, with in particular the mechanical strength and sealing of the coil 7 being effectively preserved, including during aging of the electrical apparatus 1.

In FIG. 1, the material 12 is positioned at the two ends 5a and 5b of the longitudinal cavity 5, but may, as a variant, be located only at one of the ends of the cavity 5, in particular when the cavity 5 has only one end which opens onto only one end face 5a or 5b, thus forming an opening.

The positioning of the material 12 makes it possible to prevent the risks of the material 12 coming into contact with the coil 7, minimizing the formation of air bubbles.

The electrical apparatus 1 further comprises closure means 15 each fastened to one end of the housing. The closure means 15 are separate from the material 12. The closure means 15 are removably fastened to the housing by any suitable means, here using screw threads.

The electrical apparatus 1 according to the invention thus has improved electrical performance, in particular good dielectric strength and better resistance to partial discharges.

Moreover, the risks of leakage of the dielectric fluid in the electrical apparatus 1 are reduced, or even eliminated, including after its aging, in particular under increasing DC voltages.

The examples that follow serve to illustrate the invention without, however, being limiting in nature.

### EXAMPLE

### 1. Checking the Tightness of the Gel

A transparent glass test tube was filled with 5 ml of Jarylec® C101 and then with 1 ml of BLUESIL ESA 6018-01A+1 ml of BLUESIL ESA 6018-01B, two products sold by ELKEM, to form a silicone gel. The test tube was then placed in an oven at 40° C. for 3 hours. At the end of this step, the tube can be inverted without any flow of liquid.

### 2. Determination of the Dielectric Properties of a Film Capacitor According to One Embodiment of the Invention.

### Description of the Production of Film Capacitors

The coils are manufactured with a rough polypropylene film of the PP2MAR8.3 type sold by BOLLORE Films Plastiques.

The housing used is a cylindrical housing with a volume of 250 cm³ that can be closed at both ends.

Two capacitors are produced.

In a first case (housing no. 1—invention), the housing is held in a vertical position and then filled with 8 g of BLUESIL ESA 6018-01A and 8 g of BLUESIL ESA 6018-01B in order to form a gelled layer in the lower part of the housing, i.e. at the bottom of the housing. Gelling takes place for a period of 20 hours at ambient temperature, i.e. a temperature of 23° C.

The coil is then placed in the housing containing the gel layer at the bottom of the housing and then an impregnation step is carried out with 200 g of Jarylec® C101 for 5 days at 90° C. At the end of this step and after cooling to ambient temperature, the gel components are added in a proportion of 8 g of BLUESIL ESA 6018-01A and 8 g of BLUESIL ESA 6018-01B to allow the formation of an impermeable gel on the surface. The housing is then closed. Gelling takes place for 20 hours at ambient temperature.

The dissipation factor (tangent delta) can then be measured.

In a second case (housing no. 2—comparative), the coil is impregnated with Jarylec® C101 for 5 days at 90° C., at the end of which step the excess Jarylec® fluid is removed before placing the coil in the housing. The housing is then completely filled with 116 g of BLUESIL ESA 6018-01A and 116 g of BLUESIL ESA 6018-01B. Gelling takes place for 20 hours at ambient temperature.

The dissipation factor (tangent delta) can then be measured.

The results of the tangent delta measurements were then carried out at 20° C. and the results appear in the table below. The values obtained with housing no. 1 (values less than 0.001 after 60 minutes) are excellent and significantly better than those obtained for housing no. 2.

TABLE 1

| Tangent delta value | | |
|---|---|---|
| (according to the | Housing | Housing |
| standard IEC 61260) | no. 1 | no. 2 |
| Initial value | 0.00150 | 0.063 |
| After 60 minutes | 0.00097 | 0.046 |
| After 18 hours | 0.00092 | 0.042 |

1. An electrical apparatus comprising:
a housing provided with a cavity,
a coil and at least one composition comprising at least one dielectric fluid, which are arranged inside the cavity;
a material in gelled form, arranged inside the cavity, occupying a maximum volume of less than 50% of the total volume of the cavity.

2. The electrical apparatus as claimed in claim 1, wherein said electrical apparatus is chosen from the group consisting of transformers, capacitors, bushings and load tap changers.

3. The electrical apparatus as claimed in claim 1, wherein the material in gelled form occupies a maximum volume of less than or equal to 40% of the total volume of the cavity.

4. The electrical apparatus as claimed in claim 1, wherein the material in gelled form is at least located at at least one end of the cavity.

5. The electrical apparatus as claimed in claim 1, wherein the material in gelled form is not in contact with the coil.

6. The electrical apparatus as claimed in claim 1, wherein the material in gelled form is located at least in part between the composition comprising at least one dielectric fluid and the bore of the cavity.

7. The electrical apparatus as claimed in claim 1, wherein the composition comprising the dielectric fluid is at least partially in direct contact with the cavity.

8. The electrical apparatus as claimed in claim 1, wherein the cavity comprises a longitudinal part comprising at least one end opening onto at least one of the end faces of the housing, and the material in gelled form is at least located at at least one end of the cavity.

9. The electrical apparatus as claimed in claim 1, wherein the material in gelled form is located between one of the end faces of the housing and the composition comprising the dielectric fluid.

10. The electrical apparatus as claimed in claim 1, wherein the material in gelled form is immiscible with the composition comprising the dielectric fluid.

11. The electrical apparatus as claimed in claim 1, wherein the material in gelled form is a resin chosen from the group consisting of silicone resins, polyurethane resins, polyester resins, polystyrene resins and polyethylene resins.

12. The electrical apparatus as claimed in claim 1, wherein the composition comprises a dielectric fluid chosen from the group consisting of mineral oils, synthetic oils, vegetable oils and natural esters, and mixtures thereof.

13. The electrical apparatus as claimed in claim 1, wherein the composition comprises a dielectric fluid chosen from the group consisting of mixtures of benzyltoluene and one or more aromatic compounds, other than benzyltoluene.

14. The electrical apparatus as claimed in claim 1, wherein the coil comprises a plurality of layers, connected to one another, alternating successively between an electronically conductive layer, and an electronically insulating layer.

15. A method of using a material in gelled form inside an electrical apparatus as claimed in claim 1 for preventing, and possibly eliminating, leaks of a composition comprising at least one dielectric fluid.

16. A method for manufacturing an electrical apparatus as described in claim 1, comprising:
at least one step of inserting a coil, as described above, into the cavity of the housing,
optionally, at least one step of impregnating the coil with a composition comprising at least one dielectric fluid, as described above,
at least one step of filling the cavity with a gellable composition,
at least one step of gelling said gellable composition to obtain a material in gelled form as described above;
such that the material in gelled form occupies a maximum volume of less than 50% of the total volume of the cavity.
